(19) United States
(12) Patent Application Publication
(10) Pub. No.: US 2012/0011326 A1
(43) Pub. Date: Jan. 12, 2012

(54) STORAGE SYSTEM AND METHOD FOR CHANGING CONFIGURATION OF CACHE MEMORY FOR STORAGE SYSTEM

(75) Inventors: Naoki Higashijima, Machida (JP); Yuko Matsui, Odawara (JP)

(73) Assignee: HITACHI, LTD., Tokyo (JP)

(21) Appl. No.: 12/682,757

(22) PCT Filed: Mar. 19, 2010
(86) PCT No.: PCT/JP2010/001987

§ 371 Date: Apr. 12, 2010

(51) Int. Cl. G06F 12/08

(52) U.S. Cl. 711/142; 711/E12.026

(57) ABSTRACT

The configuration of a cache memory can be changed while minimizing the influence over input-output performance with a host system on the active storage system.

A data transfer control unit transfers data via a cache memory by a write-after method; and as triggered by an event where an amount of input to and output from an object area in the cache memory falls below a certain value, the data transfer control unit switches from the write-after method to a write-through method and then transfers data via the cache memory. Subsequently, as triggered by an event where there is no longer any input to and output from the object area in the cache memory, a processor changes the configuration of the cache memory relating to the object area.

### TECHNICAL FIELD

The present invention relates to a storage system and a method for changing the configuration of a cache memory on a storage system. Particularly, the invention is ideal for use in a storage system relating to a technique of changing the configuration of the cache memory.

### BACKGROUND ART

In recent years, storage consolidation by which storage units distributed and located in each server are consolidated in one place and the consolidated storage units are connected to a group of servers via a storage-only network such as a SAN (Storage Area Network) has become widespread. As an operation form of storage consolidation, a case where a storage system shared by a plurality of application programs or contents has been increasing. The storage system is equipped with, for example, a disk array apparatus. The disk array apparatus is configured by placing many disk drives in arrays and constructed based on, for example, RAID (Redundant Array of Independent Inexpensive Disks). At least one logical volume is formed in a physical memory area provided by a group of disk drives. A host system can read data from or write data to the logical volume(s) by issuing a write command or read command to the storage system.

A conventional storage system is equipped with a cache memory for temporarily storing write data written to and read data read from disk drives, thereby realizing high-speed I/O processing with a host system. For example, regarding write access from a host system to a disk drive, when write data is written to the cache memory, the host system is notified of the completion of write processing; and then destaging is performed at a stage where a certain amount of data has been accumulated. Regarding read access from the host system to the disk drive, when the read access hits read data in the cache memory, the read data is read from the cache memory, thereby realizing high-speed access.

If the configuration of a cache memory for a conventional storage system is changed, the storage system needs to be reactivated once; and it is generally impossible to change the configuration of a cache memory while the storage system is active. There is a suggested method of making it possible to change the configuration of a cache memory in a conventional storage system while the storage system is active, by directly writing write data to logical volumes on disk drives without the temporal intermediary of the cache memory (for example, see paragraph 0077 in the specification of Patent Literature 1).

### CITATION LIST

### Patent Literature

PTL 1: Japanese Patent Laid-Open (Kokai) Application Publication No. 2006-227688

### SUMMARY OF INVENTION

### Technical Problem

A cache memory is configured to realize high-speed I/O processing with a host system as described above. Therefore, a conventional storage system has a problem of significant influence over input-output performance relating to I/O processing with the host system if the cache memory is not used at all during operating time to change the configuration of the cache memory.

The present invention was devised in light of the circumstances described above and aims at providing a storage system and a method for changing the configuration of a cache for a storage system that can change the configuration of a cache memory while minimizing the influence over input-output performance relative to a host system on the active storage system.

### Solution to Problem

In order to solve the above-described problem, the present invention provides a storage system including: a storage device for providing a logical volume which is accessible from a host system; and a controller including a data transfer control unit for controlling input to and output from the logical volume in response to an input-output request from the host system, a cache memory for temporarily storing data input to and output from the logical volume, and a processor for controlling the data transfer control unit and managing the configuration of the cache memory; wherein the data transfer control unit transfers data via the cache memory by a write-after (write-back) method; and as triggered by an event where an amount of input to and output from an object area in the cache memory falls below a certain value, the data transfer control unit switches from the write-after method to a write-through method and then transfers data via the cache memory and waits until there is no longer any input to and output from the object area in the cache memory; and wherein as triggered by an event where there is no longer any input to and output from the object area in the cache memory, the processor changes the configuration of the cache memory relating to the object area and causes the data transfer control unit to switch from the write-through method to the write-after method and resume data transfer via the cache memory.

Moreover, the invention provides a method for changing a configuration of a cache memory for a storage system, the storage system including: a storage device for providing a logical volume which is accessible from a host system; and a controller including a data transfer control unit for controlling input to and output from the logical volume in response to an input-output request from the host system, a cache memory for temporarily storing data input to and output from the logical volume, and a processor for controlling the data transfer control unit and managing the configuration of the cache memory; wherein the method includes: a change preparation step executed by the data transfer control unit for transferring data via the cache memory by a write-after method; and as triggered by an event where an amount of input to and output from an object area in the cache memory falls below a certain value, then switching from the write-after method to a write-through method and then transferring the data via the cache memory and waiting until there is no longer any input to and output from the object area in the cache memory; a configuration change step executed by the processor for changing the configuration of the cache memory relating to the object area as triggered by an event where there is no longer any input to and output from the object area in the cache memory; and a restoration step executed by the data transfer control unit for switching from the write-through method to the write-after method and resuming data transfer via the cache memory.

In order to solve the above-described problem, the present invention provides a method for changing a configuration of a cache memory for a storage system, the storage system including: a storage device for providing a logical volume which is accessible from a host system; and a controller including a data transfer control unit for controlling input to and output from the logical volume in response to an input-output request from the host system, a cache memory for temporarily storing data input to and output from the logical volume, and a processor for controlling the data transfer control unit and managing the configuration of the cache memory; wherein the method includes: a change preparation step executed by the data transfer control unit for searching an object area in the cache memory with transferring data via the cache memory by a write-after method; and if dirty data as data which has not been completely transferred to the storage device or the host system does not exist in each segment of the object area in the cache memory, then marking the segment; and if the dirty data exists in a segment of the object area in the cache memory, then copying the dirty data to a non-object segment, marking the object segment, and then deleting the dirty data existing in the object segment in the object area; a configuration change step executed by the processor for changing the configuration of the cache memory relating to the object area as triggered by an event where the dirty data no longer exists in the object area in the cache memory; and a restoration step executed by the data transfer control unit for cancelling the mark given to each segment in the object area in the cache memory and resuming data transfer via the cache memory.

### ADVANTAGEOUS EFFECTS OF INVENTION

According to this invention, it is possible to change the configuration of a cache memory while minimizing the influence on the input-output performance relative to a host system on the active storage system.

### BRIEF DESCRIPTION OF DRAWINGS

FIG. 1 is a block diagram of the outline configuration of a storage system according to an embodiment of this invention.

FIG. 2 is a block diagram showing an example of the main configuration of a controller.

FIG. 3 is a diagram showing the outline of dual writing to cache data by dual controllers.

FIG. 4 is a diagram showing an example of the table configuration of an LU management table.

FIG. 5 is a diagram showing an example of the table configuration of a cache partition management table.

FIG. 6 is a diagram showing an example of partition setting for a cache memory.

FIG. 7 is a diagram showing an example of the configuration of user data areas after a configuration change.

FIG. 8 is a diagram showing the correspondence relationship between host systems and LUs before a configuration change.

FIG. 9 is a diagram showing the correspondence relationship between the host systems and the LUs after a configuration change.

FIG. 10 is a diagram showing an example of the table configuration of the LU management table after a configuration change.

FIG. 11 is a diagram showing an example of the table configuration of the cache partition management table after a configuration change.

FIG. 12 is a diagram showing the correspondence relationship between segments, parent subsegment management blocks, and child subsegment management blocks before a configuration change.

FIG. 13 is a diagram showing the correspondence relationship between segments, parent subsegment management blocks, and child subsegment management blocks after a configuration change.

FIG. 14 shows an example of steps of a method for changing the configuration of a cache memory according to a first embodiment.

FIG. 15 shows an example of steps of a method for changing the configuration of a cache memory according to a second embodiment.

FIG. 16 is a diagram showing a format example of cache memories before the configuration of their memory areas is changed.

FIG. 17 is a diagram showing a format example of the cache memories after the configuration of their memory areas is changed.

### DESCRIPTION OF EMBODIMENTS

An embodiment of the present invention will be explained with reference to the attached drawings.

### (1) First Embodiment

### (1-1) Configuration of Storage System

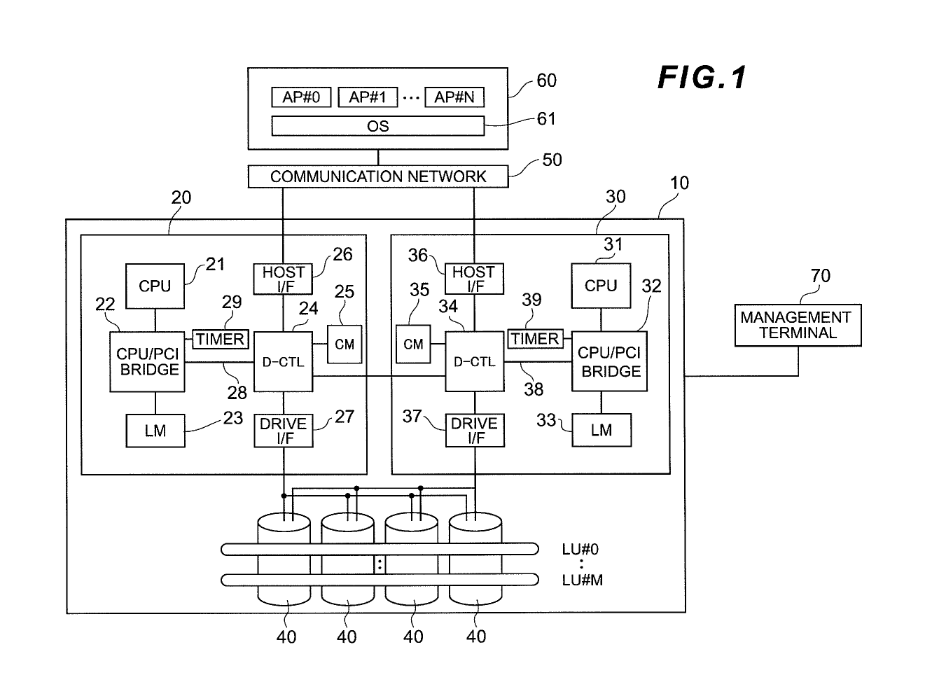

FIG. 1 shows the main configuration of a storage system 10 according to a first embodiment. The storage system 10 is connected via a communication network 50 to one or more host systems 60. The host system 60 is, for example, a server device, computer, workstation, or mainframe that functions as a host system in the storage system 10. The host system 60 has a plurality of application programs AP #0, AP #1, and so on to AP #N operating on an OS (Operating System) 61. Storage resources provided by the storage system 10 are shared by the plurality of application programs AP #0, AP #1, and so on to AP #N.

Examples of the communication network 50 include a SAN (Storage Area Network), a LAN (Local Area Network), the Internet, private lines, or a public circuit. If the host system 60 is connected via a SAN to the storage system 10, the host system 60 requests data input-output by blocks, which are data management units of storage resources in the storage system 10, in accordance with Fibre Channel Protocol. If the host system 60 is connected via a LAN to the storage system 10, the host system 60 requests data input-output by files by designating a fine name according to a protocol such as NFS (Network File System) or iSCSI (interne Small Computer System Interface). The storage system 10 must have a NAS (Network Attached Storage) function to accept a file access request from the host system 60.

The storage system 10 adopts a dual controller configuration in which two redundant controllers 20, 30 are provided; and the storage system 10 includes a plurality of disk drives 40 as storage devices provided to the plurality of application programs AP #0, AP #1, and so on to AP #N. As the disk drives 40, a plurality of disk drives having different performance characteristics such as Fibre Channel disk drives, serial ATA disk drives, parallel ATA disk drives, and SCSI disk drives may be used; or any one type of disk drives from among the above-listed disk drives may be used. The term “performance characteristics” herein means, for example, a speed of access to the disk drives. Incidentally, the types of the storage devices are not limited to those listed above and, for example, optical disks, semiconductor memories, magnetic tapes, or flexible disks may be adopted.

The controllers 20, 30 can control the plurality of disk drives 40 according to a RAID level (for example, 0, 1, 5, or 6) specified by a RAID method. According to the RAID method, for example, the plurality of disk drives 40 are managed as one RAID group. A plurality of logical volumes which are units of access from the host system 60 are defined on the RAID group. In other words, the disk drives 40 provide logical volumes which are accessible from the host system 60. Each logical volume is assigned an identifier called an “LU number (LUN: Logical Unit Number)” such as LU #0, LU #1, and so on to LU #M. This LU number can be also assigned to the entire area or each partition of a memory area of a cache memory 25. Incidentally, the logical volume will be hereinafter also referred to as the LU.

The controller 20 is equipped with a CPU 21, a CPU/PCI bridge 22, a local memory (corresponding to LM in FIG. 1) 23, a data transfer control unit (corresponding to D-CTL in FIG. 1) 24, a cache memory (corresponding to CM in FIG. 1) 25, a host I/F control unit 26, a drive I/F control unit 27, and a timer 29. The controller 20 has the timer 29, so that when previously set time has come, the CPU 21 changes the configuration of the cache memory 25.

The host I/F control unit 26 is a controller for controlling an interface with the host system 60 and has, for example, a function that receives a block access request from the host system 60 according to the Fibre Channel Protocol. The drive I/F control unit 27 is a controller for controlling an interface with the disk drives 40 and has, for example, a function that controls a data input-output request to the disk drives 40 according to a protocol for controlling the disk drives 40.

The CPU 21 is an example of a processor and controls I/O processing (write access or read access) on each disk drive 40 by responding to a data input-output request from the host system 60 and controlling the data transfer control unit 24. The CPU 21 manages the configurations of the cache memory 25 and storage devices 40 in the storage system 10. The CPU 21 manages, for example, an LU management table and a cache partition management table relating to the configuration of the cache memory 25. The local memory 23 stores a microprogram of the CPU 21. The CPU/PCI bridge 22 connects the CPU 21, the local memory 22, and the data transfer control unit 24 to each other.

The cache memory 25 is a buffer memory for temporarily storing data to be written to the disk drives 40 (hereinafter sometimes referred to as the write data) and temporarily storing data read from the disk drives 40 (hereinafter sometimes referred to as the read data). The cache memory 25 is backed up by a power source which is different from a main power source; and the cache memory 25 is configured as a nonvolatile memory that prevents data loss even if a power supply failure occurs in the storage system 10. Data stored in the cache memory 25 is sometimes referred to as the cache data in the present embodiment.

The data transfer control unit 24 is connected to the CPU/PCI bridge 22, the cache memory 25, the host I/F control unit 26, and the drive I/F control unit 27. The data transfer control unit 24 and the CPU/PCI bridge 22 are connected each other via a PCI bus 28. The data transfer control unit 24 controls data transfer between the host system 60 and the disk drives 40 under the control of the CPU 21.

Specifically speaking, when the host system 60 makes write access, the data transfer control unit 24 writes the write data, which has been received from the host system 60 via the host I/F control unit 26, to the cache memory 25. Subsequently, the data transfer control unit 24 transfers the write data to the drive I/F control unit 27 in order to asynchronously write the write data to the disk drives 40.

On the other hand, if the host system 60 makes read access, the data transfer control unit 24 writes the read data, which has been received from the disk drives 40 via the drive I/F control unit 27, to the cache memory 25. Subsequently, the data transfer control unit 24 transfers the read data to the host I/F control unit 26.

The controller 30 is equipped with a CPU 31, a CPU/PCI bridge 32, a local memory (LM in FIG. 1) 33, a data transfer control unit (D-CTL in FIG. 1) 34, a cache memory (CM in FIG. 1) 35, a host I/F control unit 36, and a drive I/F control unit 37. Because the configuration of the controller 30 is almost the same as that of the controller 20, an explanation about the configuration of the controller 30 has been omitted; and unless particularly necessary, the controller 20 will be mainly explained.

The data transfer control units 24, 34 in the controllers 20, 30 are connected to each other via a data bus. Data is transferred between the data transfer control units 24, 34 so that data written to one cache memory 25 (or 35) is also written doubly to the other cache memory 35 (or 25). If the disk drives 40 are managed according to RAID level 5, the data transfer control units 24, 34 calculate parity data.

The storage system 10 is connected to a management terminal 70 for maintaining or managing the system, and data is transferred between the storage system 10 and the management terminal 70 according to a specified communication protocol such as the Fibre Channel Protocol or TCP/IP. Incidentally, the management terminal 70 may be configured so that it is embedded in the storage system 10 or attached externally to the storage system 10. An administrator can change the configuration of the storage system 10 by operating a management application installed in the management terminal 70 (hereinafter sometimes referred to as the Storage Navigator). The Storage Navigator can be operated when the administrator unlocks the Storage Navigator by entering a specified key. As the Storage Navigator issues a command to a configuration management application program installed in the controller 20 according to the operation or reservation of the administrator, it can perform operations such as changing the configuration of the storage system 10 (for example, the cache memory 25). Examples of such a configuration management application include Cache Partition Manager for changing the partition configuration of the cache memory 25 or a program product described later (hereinafter sometimes referred to as the PP).

Examples of such a configuration change generally include setting of logical volumes defined on the disk drives 40, addition or removal of a disk drive 40, and a setting change of the RAID configuration. Examples of such a setting change of the RAID configuration can include a change from RAID level 5 to RAID level 1. Furthermore, examples of such a configuration change in the present embodiment can include optimum performance tuning of the cache memories 25, 35 relative to each individual application program AP #0, AP #1, and so on to AP #N. Examples of such tuning can include partitioning, partition size setting, segment size setting, setting of whether duplexing is necessary or not, and setting to allocate, or change the allocation of, logical volumes to partitions. The above-mentioned settings are managed by the LU management table and cache partition management table mentioned above.

### (1-2) Configuration of Memory Area of Cache Memory

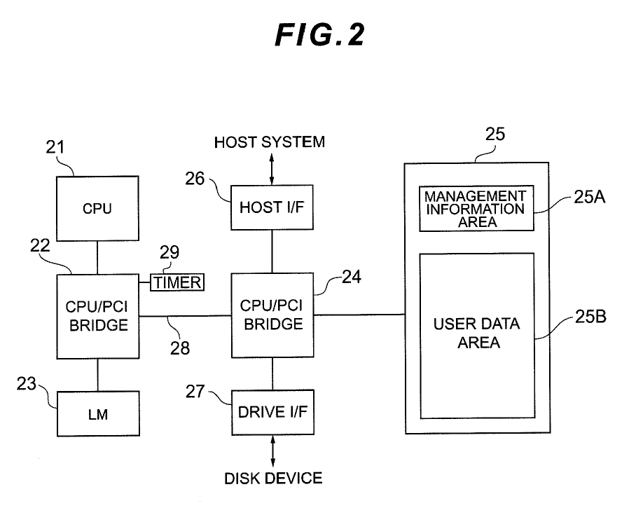

FIG. 2 shows the main configuration of the controller 20. Incidentally, since the configuration of the controller 30 is almost the same as that of the controller 20, the controller 20 will be mainly explained below. The cache memory 25 is managed by dividing its memory area into a management information area 25A and a user data area 25B.

The user data area 25B is a memory area for temporarily storing user data which corresponds to the cache data described later and is divided into a plurality of partitions corresponding to the plurality of application programs described above. The management information area 25A stores management information necessary to manage the user data, for example, data attributes (read data or write data), a logical address of the user data as designated by the host system 60, information about free areas in the cache memory 25, and information about priorities regarding replacement of the cache data.

### (1-3) Dual Writing of Cache Data

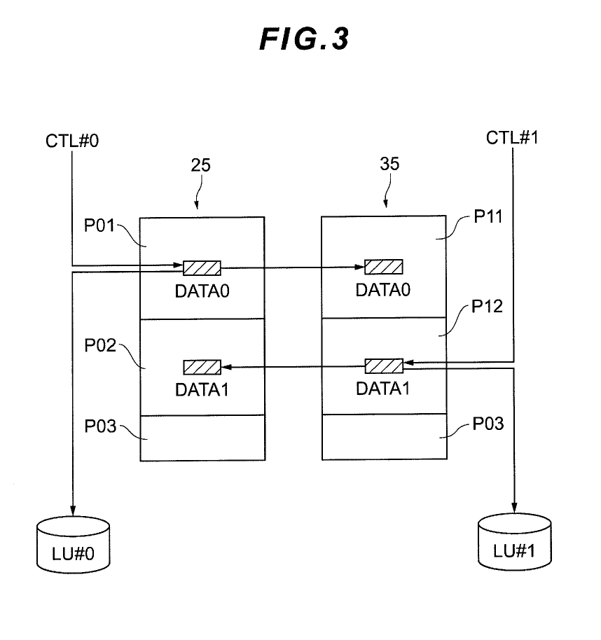

FIG. 3 shows the outline of dual writing of cache data by the dual controllers. In the following explanation, the controller 20 will be referred to as controller CTL #0 and the controller 30 will be referred to as controller CTL #1. Each controller CTL #0, CTL #1 is assigned logical volumes to which it is authorized to make exclusive access. For example, the controller CTL #0 is authorized to make exclusive access to a logical volume LU #0, while the controller CTL #1 is authorized to make exclusive access to a logical volume LU #1. Regarding which logical volume LU #0, LU #1 is exclusively assigned to which controller CTL #0, CTL #1, each controller CTL #0, CTL #1 can recognize its own access authority by, for example, writing setting information to the management information area (see FIG. 2) or like in the cache memory 25, 35.

The cache memory 25 is divided into a plurality of memory areas P01, P02, P03, and the cache memory 35 is divided into a plurality of memory areas P11, P12, P13. The memory area P01 is a memory area for temporarily storing cache data DATA0 to be read from or written to logical volumes (such as LU #0) exclusively allocated to the controller CTL #0, and dual writing is set to the memory area P01 (mirror-on setting). Specifically speaking, the cache data DATA0 written to the memory area P01 is also written to the memory area P11 under the control of the controller CTL #0. The memory area P11 is a memory area for mirroring by the controller CTL #0.

Similarly, the memory area P12 is a memory area for temporarily storing cache data DATA1 to be read from or written to logical volumes (such as LU #1) exclusively allocated to the controller CTL #1, and dual writing is set to the memory area P12. Specifically speaking, the cache data DATA1 written to the memory area P12 is also written to the memory area P02 under the control of the controller CTL #1. The memory areas P03, P13 are memory areas to which dual writing is not set (mirror-off setting). Incidentally, the memory areas P01, P02, P11, P12 to which dual writing is set will be hereinafter referred to as the mirror-on areas, while the memory areas P03, P13 to which dual writing is not set will be hereinafter referred to as the mirror-off areas.

### (1-4) Table Configuration

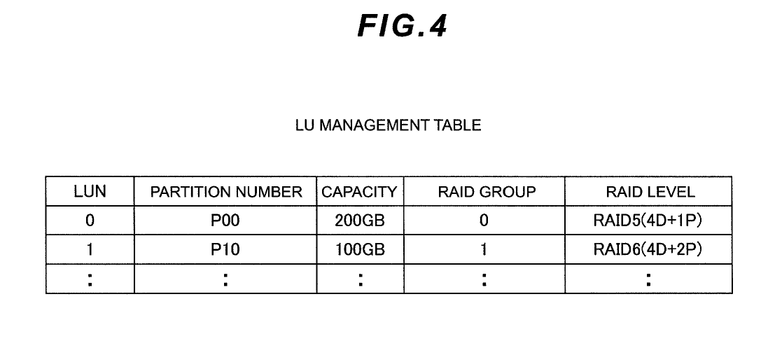

FIG. 4 shows an example of the table configuration of the LU management table. The LU management table manages the partition number, capacity, RAID group, and RAID level for each LU number (LUN in FIG. 4). The LU number is a number used to identify each of the logical volumes described above. The partition number is a number used to identify each partition. The capacity represents the capacity of each logical volume. The RAID group represents a RAID group to which each logical volume belongs. The RAID level represents which RAID level each logical volume corresponds to.

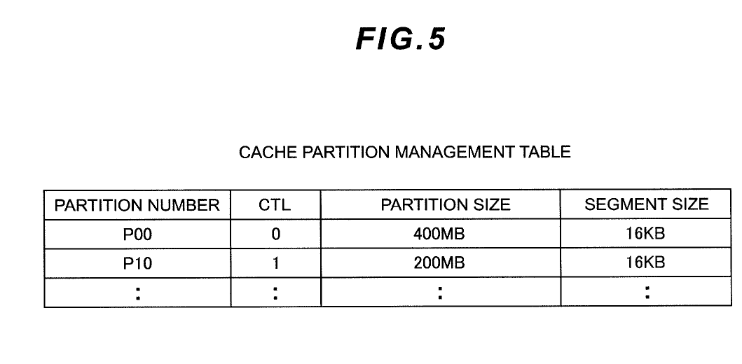

FIG. 5 shows an example of the table configuration of the cache partition management table. The cache partition management table manages the controller type (corresponding to CTL in FIG. 5), partition size, and segment size for each partition number.

The partition number corresponds to the above-described partition number shown in FIG. 4. The controller type is set to 0 when a partition corresponding to the relevant partition number is allocated to the controller CTL #0; and the controller type is set to 1 when a partition corresponding to the relevant partition number is allocated to the controller CTL #1. The partition size represents the size of data allocated to each partition. The segment size represents the size of a segment set within the relevant partition.

### (1-4) Partition Setting of Cache Memory

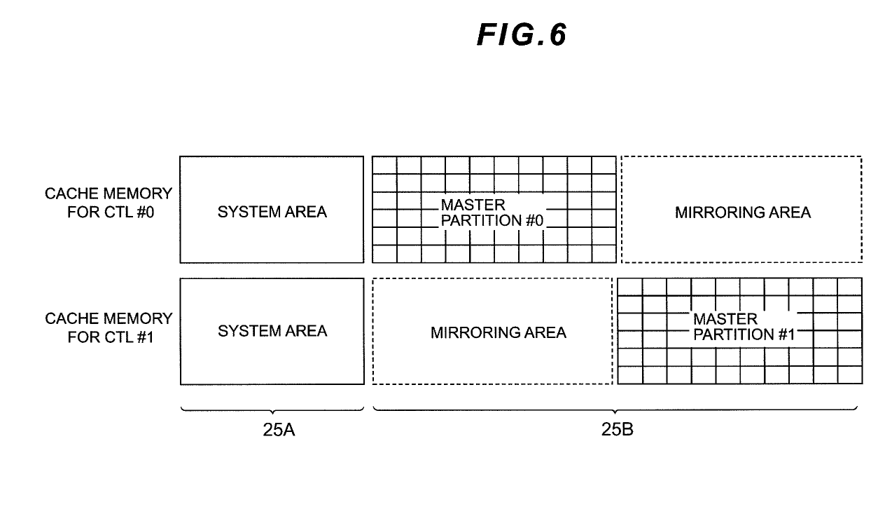

FIG. 6 shows an example of the partition setting in the cache memories 25, 35. This partition setting shows areas actually divided based on the records in FIG. 4 and FIG. 5 described above. The memory area of the cache memory 25, 35 has a system area corresponding to the management information area 25A described above, and the user data area 25B described above. Incidentally, the segment size of a master partition #0 is 16 kB.

A master partition #0 and a mirroring area are managed in the memory area of the cache memory 25 for the controller CTL #0. On the other hand, a mirroring area for mirroring of the master partition #0, and a master partition #1 are managed in the memory area of the cache memory 25 for the controller CTL #1. This master partition #1 is mirrored in the mirroring area for the controller CTL #0.

### (1-6) Configuration Change of User Data Area

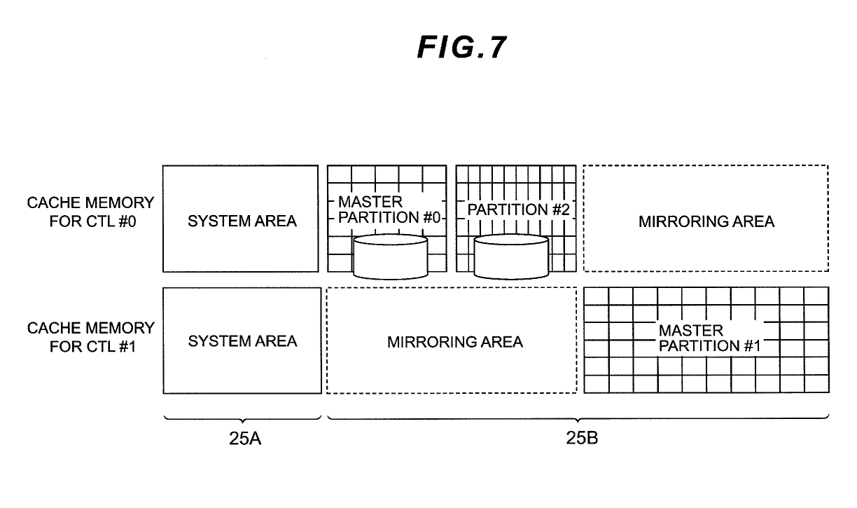

FIG. 7 shows an example of the configuration of the user data areas after a configuration change. As an example according to the present embodiment, part of the master partition #0 whose segment size is 16 kB is changed to another partition #2, so that the segment size of the other partition #2 is changed to 32 kB. In this case, the master partition #0 and the other partition #2 are mirrored in the mirroring area for the controller CTL #1. Such a configuration change is performed by Cache Partition Manager from among the aforementioned configuration management applications. Then, the following LU mapping is performed in the present embodiment.

### (1-7) LU Mapping

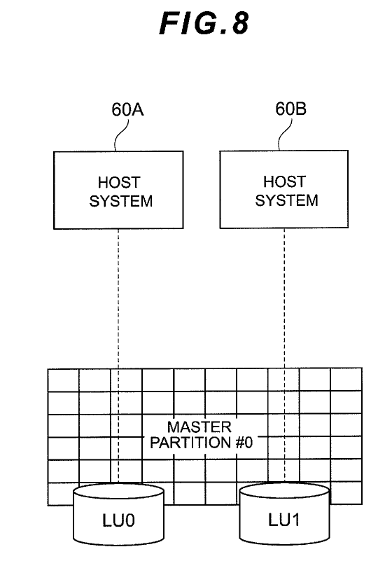

FIG. 8 shows the correspondence relationship between the host systems 60 and logical volumes (LUs) before a configuration change. FIG. 8 shows a case where a plurality of host systems 60 described above exist. In the master partition #0, one host system 60A corresponds to a logical unit number LU0 and the other host system 60B corresponds to a logical unit number LU1.

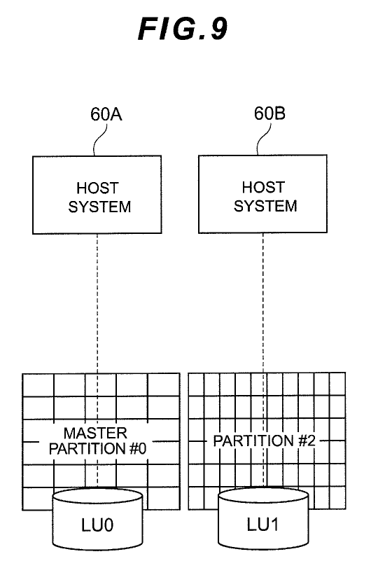

FIG. 9 shows the correspondence relationship between the host systems 60 and logical volumes (LUs) after a configuration change. FIG. 9 shows a case where a plurality of host systems 60 described above exist. Logical volumes are allocated to the master partition #0 and one host system 60A corresponds to the logical unit number LU0. Regarding the master partition #2, the other host system 60B corresponds to the logical unit number LU1.

When such a configuration change is made, the cache partitions used by the host systems 60 are changed. Performance relating to I/O processing with the host systems can be enhanced by segment management of these partitions in accordance with I/O characteristics of the host systems 60. The host systems 60 are connected with the LUs by means of LU mapping, and the LUs are connected with the cache partitions. Accordingly, an optimum combination of the “host system 60 to LUs to cache partitions” can be obtained by making the partition setting that matches an I/O pattern of the host system 60.

### (1-8) Table Configuration after Configuration Change

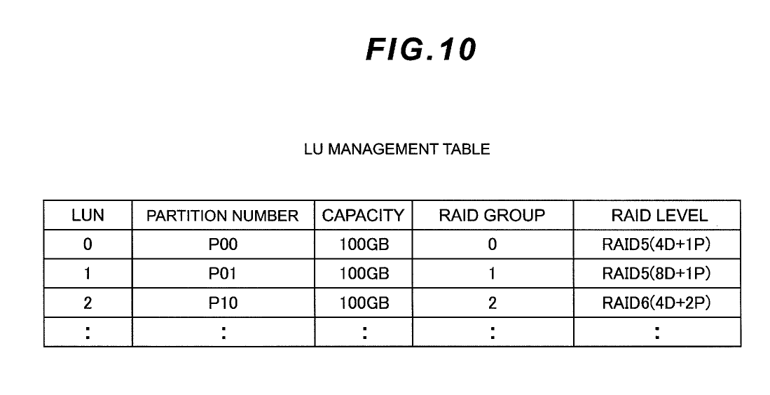

FIG. 10 shows an example of the table configuration of the LU management table after a configuration change. The LU management table manages the partition number, capacity, RAID group, and RAID level for each LU number (corresponding to LUN in FIG. 10) as records corresponding to the partition number P01 for a new partition #1.

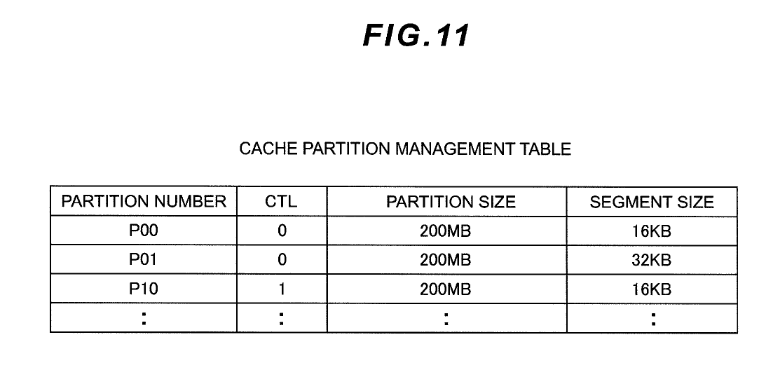

FIG. 11 shows an example of the table configuration of the cache partition management table after a configuration change. Like the cache partition management table described above and shown in FIG. 4, this cache partition management table manages the controller type (corresponding to CTL in FIG. 11), partition size, and segment size for each partition number. Records corresponding to the partition number P01 for the new partition #1 are added to the cache partition management table.

### (1-9) Segment Management

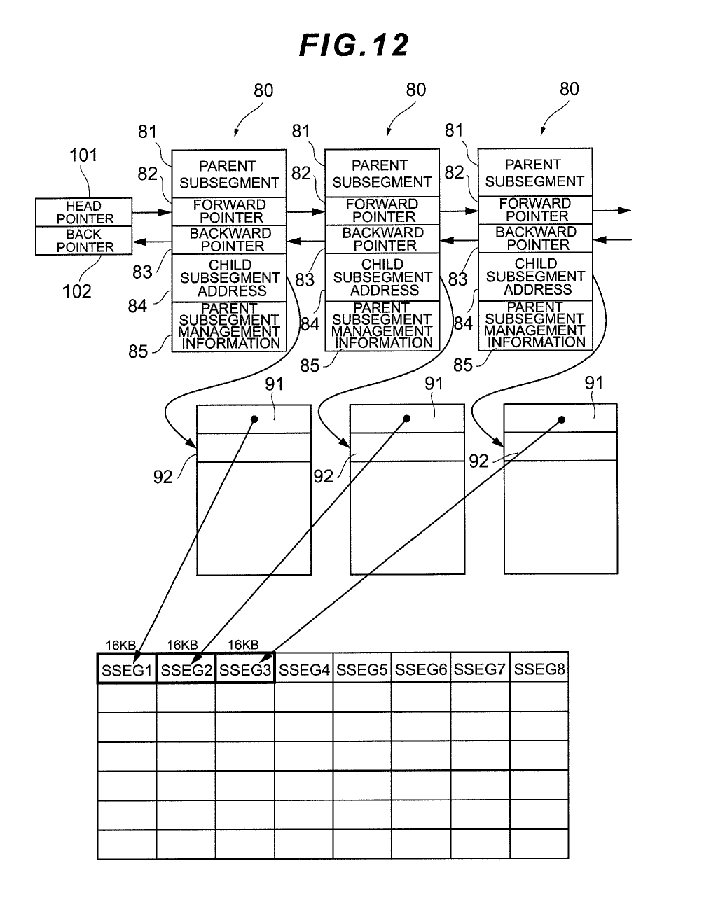

FIG. 12 shows the correspondence relationship between segments, parent subsegment management blocks, and child subsegment management blocks before a configuration change. In the present embodiment, a segment is composed of one or more subsegments and the segment size is adjusted by adjusting the number of segments to constitute a segment. The subsegment size is set in advance to a fixed size. When a segment is composed of a plurality of subsegments, a subsegment that is first accessed in the segment is called a “parent subsegment” and the second and subsequent accessed segments are called “child subsegments.” If subsegments are not differentiated between the parent subsegment and the child subsegments, they are simply called “subsegments.”

Referring to FIG. 12, SSEG1 to SSEG8 represent accessed subsegments in the order of access. If a default subsegment size is set to 16 KB, it is necessary to gather four subsegment to construct a segment in order to realize the segment size of 64 KB. For example, one segment of 16 KB can be constructed by using SSEG1 as a parent subsegment and not logically associating its subsequent subsegment SSEG2 as a child subsegment. Similarly, one segment of 16 KB can be constructed by using SSEG2 as a parent subsegment and not logically associating its subsequent subsegment SSEG3 as a child subsegment.

Incidentally, parent subsegments and child subsegments do not necessarily have to be located in continuous memory areas and may be located discretely at different places in the cache memory 25.

A parent subsegment management block 80 includes a parent subsegment address 81, a forward pointer 82, a backward pointer 83, a child subsegment address 84, and a parent subsegment management information 85. The parent subsegment address 81 indicates the position of a parent subsegment managed by the parent subsegment management block 80. The forward pointer 82 points to the parent subsegment management block 80 in the order of oldest access to latest access. The backward pointer 83 points to the parent subsegment management block 80 in the order of latest access to oldest access. The child subsegment address 84 points to a child subsegment management block 90. The parent subsegment management information 85 stores, for example, the status (dirty/clean/free) of the relevant parent subsegment. The word “dirty” herein means the state where data of the relevant parent subsegment has not been transferred to logical volumes on the storage devices 40. The word “clean” herein means that the state where data of the relevant parent subsegment has been transferred to the logical volumes on the storage devices 40. If both dirty data and clean data are present and mixed in a parent subsegment, the status of the parent subsegment is managed by bitmap information.

A child subsegment management block 90 includes a child subsegment address 91, a forward pointer 92, and child subsegment management information 93. The child subsegment address 91 indicates the position of a child subsegment managed by the child subsegment management block 90. The forward pointer 92 points to the child subsegment management block 90 in the order of oldest access to latest access. The child subsegment management information 93 stores, for example, the status of the child subsegment. If both dirty data and clean data are present and mixed in a child subsegment, the status of the child subsegment is managed by bitmap information. A head pointer 101 points to the last forward pointer 81, and a back pointer 102 is pointed by the top backward pointer 82.

If the status of the parent subsegment management blocks 80 and the child subsegment management blocks 90, for which queue management is conducted in the manner described above, is dirty (dirty data), they are managed as dirty queues; and if the status of the parent subsegment management blocks 80 and the child subsegment management blocks 90 is clean (clean data), they are managed as clean queues. As a parent subsegment and a plurality of child subsegments are logically associated with each other to construct a segment, if the state transition of the parent subsegment occurs, the state transition of the child subsegments also occur. Therefore, it is possible to increase the speed of destaging processing.

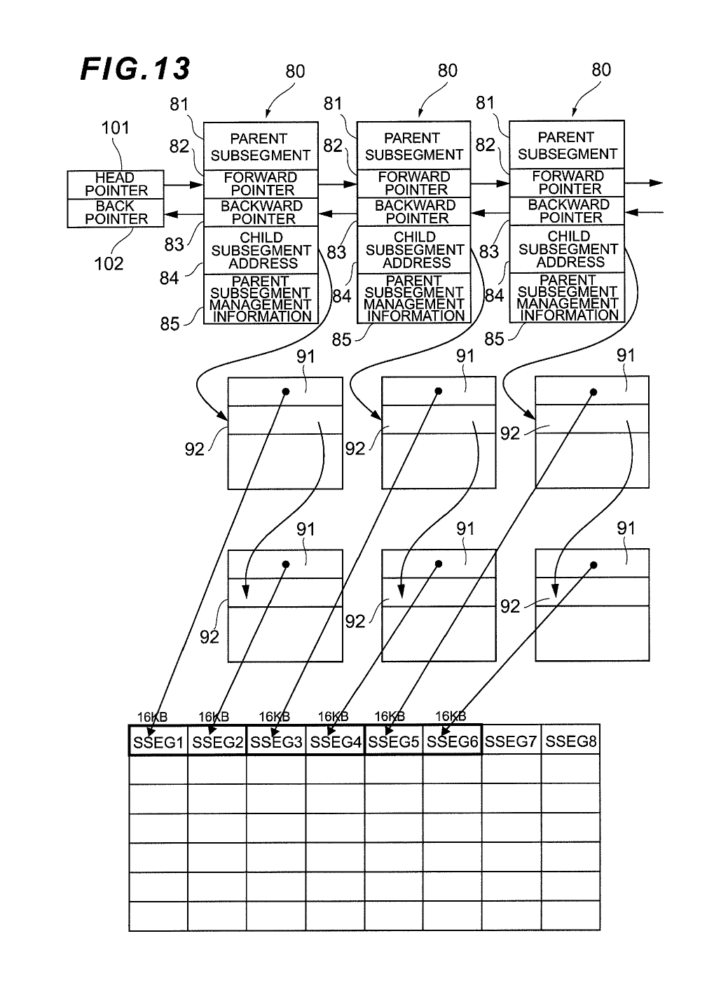

FIG. 13 shows the correspondence relationship between segments, parent subsegment management blocks, and child subsegment management blocks after a configuration change. Incidentally, any part of the explanation about FIG. 13 that overlaps with the above explanation about FIG. 12 has been omitted as a general rule.

Referring to FIG. 13, SSEG1 to SSEG8 represent accessed subsegments in the order of access. If a default subsegment size is set to 16 KB, it is necessary to gather two subsegments to construct a segment in order to realize the segment size of 32 KB. For example, one segment of 32 KB can be constructed by using SSEG1 as a parent subsegment and one subsequent subsegment SSEG2 as a child subsegment and logically associating them with each other. Similarly, one segment of 32 KB can be constructed by using SSEG3 as a parent subsegment and one subsequent subsegment SSEG4 as a child subsegment and logically associating them with each other. Furthermore, one segment of 32 KB can be constructed by using SSEG5 as a parent subsegment and one subsequent subsegment SSEG6 as a child subsegment and logically associating them with each other.

### (1-9) Examples of Actions of Storage System

The storage system 10 having the above-described configuration performs the following actions.

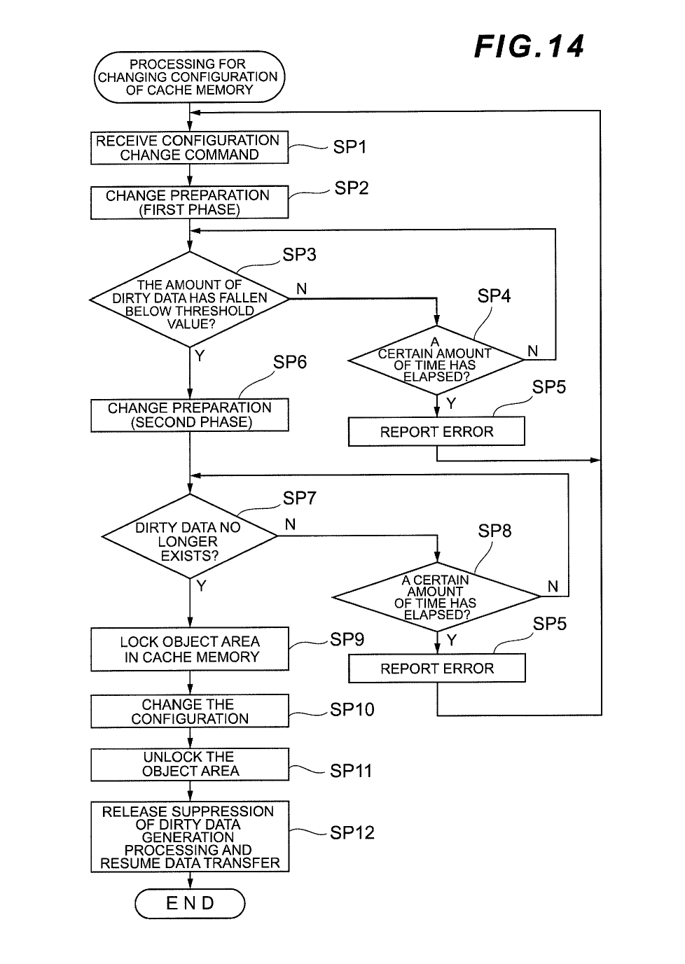

Incidentally, FIG. 14 shows an example of steps of a method for changing the configuration of the cache memory 25 according to the first embodiment. A precondition for the following actions is that the data transfer control unit 24 manages data in the host system 60 and data in the cache memory 25 by synchronizing them and also manages the data in the cache memory 25 and data in logical volumes on the storage device 40 asynchronously.

After receiving a configuration change command from the host system 60 via the host I/F control unit 26 (SP1), the data transfer control unit 24 executes the following processing under the control of the CPU 21.

(1-9-1) Change Preparation (First Phase)

The data transfer control unit 24 suppresses the execution of dirty data generation processing so that the amount of input to and output from an object area in the cache memory 25 (LUs in the object area), which is a target of the configuration change command, falls below a certain value; and also starts destaging by LU units allocated to the object area in the cache memory 25 by a write-after (write-back) method (SP2). The term “write-after method” herein means a data transfer method by which once data from the host system 60 is temporarily stored in the cache memory 25, a data storage completion report is made to the host system 60 when the data is stored in the cache memory 25 even before the data is transferred to the storage devices 40. If such a write-after method is used, it is possible to make the transition to a second phase change preparation (described later) at a high speed without degrading data transfer performance in the I/O processing with the host system 60. Examples of the dirty data generation processing can be any one of, or a combination of, LU format processing such as quick formatting, processing by a forced parity circuit, and drive restoration processing. If the above-described first phase change preparation is performed and if the input-output load on the object area in the cache memory 25 is heavy, it is possible to execute the second phase change preparation described below by avoiding such timing.

(1-9-2) First Change Preparation Step

The data transfer control unit 24 transfers data via the cache memory 25 by the write-after method and checks whether the amount of dirty data existing in the object area in the cache memory 25 has fallen below a threshold value or not (SP3). Specifically speaking, the data transfer control unit 24 checks whether the amount of input to and output from the object area in the cache memory 25 has fallen below a certain value or not.

Incidentally, dirty data is data that exists in the object area in the cache memory 25 and has not been completely written to the logical volumes on the storage devices 40. On the other hand, clean data is data that exists in the object area in the cache memory 25 and has been completely written to the logical volumes on the storage devices 40.

A method of checking the amount of dirty data is for the data transfer control unit 24 to refer to bitmap information that corresponds to the memory areas in, for example, the cache memory 25 and check if any dirty data exists or not. This bitmap information is information indicating, for example, what kind of data exists in each subsegment of the memory areas in the cache memory 25.

If the amount of dirty data existing in the object area in the cache memory 25 is not below a threshold value, the data transfer control unit 24 checks whether or not a certain amount of time has elapsed since the transition was made to the first phase (SP4). If a certain amount of time has elapsed, the data transfer control unit 24 notifies the management terminal 70 that the configuration cannot be changed because, for example, the I/O processing load is high (SP5). On the other hand, if a certain amount of time has not elapsed, the data transfer control unit 24 returns to step SP3 and checks again whether or not the amount of dirty data has fallen below the threshold value.

(1-9-3) Change Preparation (Second Stage)

If the amount of dirty data has become less than the threshold value (SP3), the data transfer control unit 24 performs second phase change preparation. In this second phase change preparation, the data transfer control unit 24 suppresses the dirty data generation processing on the partitions (their LUs) in the object area in the cache memory 25, which is the target to be changed, and starts destaging the dirty data, for example, by LU units by means of input-output by the write-through method. The term “write-through method” herein means a data transfer method by which a data write completion report is made to the host system 60 when writing of data, which is from the host system 60 and temporarily stored in the cache memory 25, to the logical volumes on the storage devices 40 is completed.

Next, the data transfer control unit 24 transfers data via the cache memory 25 and checks whether or not any dirty data exists in the object area in the cache memory 25 (SP6). Since by the write-through method the data transfer control unit 24 sends the write completion notice to the host system 60 after the data stored in the cache memory 25 is written to the disk drives 40, no dirty data is generated in the object area in the cache memory 25.

The data transfer control unit 24 checks whether or not any dirty data exists in the object area in the cache memory 25 (SP7). Specifically speaking, the data transfer control unit 24 checks whether or not there is no longer any input to and output from the object area in the cache memory 25. If the dirty data still exists, the data transfer control unit 24 checks whether or not a certain amount of time has elapsed since the transition was made to the second phase change preparation. If a certain amount of time has elapsed, the data transfer control unit 24 executes step SP5 described above; and if a certain amount of time has not elapsed, the data transfer control unit 24 returns to step SP7 described above and checks again whether any dirty data exists or not.

(1-9-4) Configuration Change Step

Meanwhile, if the dirty data no longer exists in the object area in the cache memory 25 in step SP7 described above, the data transfer control unit 24 locks the object area (or LU of the object area) in the cache memory 25 (SP9), and regulates input to and output from the object area in the cache memory 25. Next, the administrator unlocks the object area in the cache memory 25 by entering a specified key to the Storage Navigator installed in the management terminal 70, and then performs operation to change the configuration of the object area in the cache memory 25. As a result, the CPU 21 as the processor changes the configuration of the cache memory 25 relating to the object area based on the input from the Storage Navigator by having, for example, Cache Partition Manager change specified configuration information (corresponding to information such as the LU management table and the partition management table) (SP10). As a result of the above-described procedures, time during which the object area in the cache memory 25 is locked can be shortened.

(1-9-5) Restoration Step

The data transfer control unit 24 unlocks the object area (or LUs of the object area) in the cache memory 25 and releases the regulation of the input to and output from the object area (SP11). Subsequently, the data transfer control unit 24 releases the suppression of the dirty data generation processing. Next, the data transfer control unit 24 switches from the write-through method to the write-after method and resumes data transfer via the cache memory 25 (SP12).

### (1-10) Advantageous Effects of the Present Embodiment

The following change preparation step is executed according to the first embodiment.

The data transfer control unit 24 transfers data via the cache memory 25 by the write-after method; and as triggered by an event where the amount of input to and output from the object area in the cache memory 25 falls below a certain value, the data transfer control unit 24 switches from the write-after method to the write-through method, transfers data via the cache memory 25, and waits until there is no longer any more input to and output from the object area in the cache memory 25. As triggered by the event where there is no longer any input to and output from the object area in the cache memory 25, the processor 21 changes the configuration of the cache memory 25 relating to the object area and has the data transfer control unit 24 switch from the write-through method to the write-after method and resume data transfer via the cache memory 25.

If the configuration of the cache memory 25 is changed in the manner described above, the data transfer control unit 24 keeps using the cache memory 25 and also employs the write-after method as a transfer method until the amount of input to and output from the object area in the cache memory 25 falls below a certain value. Accordingly, it is possible to curb the influence over input-output performance on the host system 60. As a result, the CPU 21 can change the configuration of the cache memory 25 while curbing the influence on the input-output performance on the host system 60 and keeping the storage system active.

The following first and second change preparation steps are further executed as the above-described change preparation step according to the present embodiment. In the first change preparation step, the data transfer control unit 24 checks whether the amount of dirty data as data which exists in the object area in the cache memory 25 and has not been completely written to the logical volumes has fallen below a specified threshold value or not. On the other hand, in the second change preparation step, as triggered by the event where the amount of dirty data has fallen below the specified threshold value, the data transfer control unit 24 switches from the write-after method to the write-through method, transfers data via the cache memory 25, and then checks whether any dirty data exists in the object area in the cache memory 25. Furthermore, in the second change preparation step, as triggered by the event where the dirty data no longer exists in the object area in the cache memory 25, the processor 21 changes the configuration of the cache memory 25 relating to the object area.

As a result, since the first change preparation step adopts the write-after method, it is possible to avoid degradation of the input-output performance on the host system 60 and decide timing to execute the second change preparation step. If the I/O processing load on the host system 60 is heavy, it is possible to decide not to execute the second change preparation step. On the other hand, in the second change preparation step, data is transferred via the cache memory 25 by the write-through method which will not generate dirty data, although this may temporarily degrade the input-output performance on the host system. Therefore, it is possible in the second change preparation step to suppress the generation of dirty data in the cache memory 25 so that eventually there will be no dirty data in the object area in the cache memory 25. As triggered by the event where the dirty data no longer exists in the object area in the cache memory 25, the CPU 21 changes the configuration of the cache memory 25 relating to the object area. As a result, the object area in the cache memory 25 is changed while the power is kept on. Finally, the data transfer control unit 24 switches from the write-through method, which has been temporarily switched, to the write-after method, maintains the input-output performance on the host system 60, and resumes data transfer via the object area in the cache memory 25 having the changed configuration.

In the present embodiment, the data transfer control unit 24 further suppresses the execution of the dirty data generation processing so that the amount of input to and output from the object area in the cache memory 25 falls below a certain value.

Furthermore, in the configuration change step according to the present embodiment, the data transfer control unit 24 regulates input to and output from the object area in the cache memory 25 and then the CPU 21 changes the configuration of the cache memory 25 relating to the object area. On the other hand, in the restoration step, the data transfer control unit 24 releases the regulation of the input to and output from the object area in the cache memory 25, and then switches from the write-through method to the write-after method and resumes data transfer via the cache memory 25.

Furthermore, according to the present embodiment, the data transfer control unit 24 destages the dirty data at each logical volume corresponding to the logical unit number assigned to the object area in the cache memory 25.

According to the present embodiment, the data transfer control unit 24 further manages, for example, data in the host system 60 and data in the cache memory 25 by synchronizing them, while it manages the data in the cache memory 25 and data in logical volumes on the storage devices 40 asynchronously.

As a result, it is possible to change the configuration of the cache memory 25 while minimizing the influence on the input-output performance on the host system 60 and keeping the storage system active even if the data transfer method which may easily generate dirty data in the cache memory 25 (for example, the write-after method) is adopted.

### (2) Second Embodiment

Because the second embodiment is almost the same as the first embodiment, components similar to that of the first embodiment are given the same reference numerals as used in the first embodiment; and the second embodiment will be explained below by focusing on the difference between the first and second embodiments.

### (2-1) Method for Changing Configuration of Cache Memory

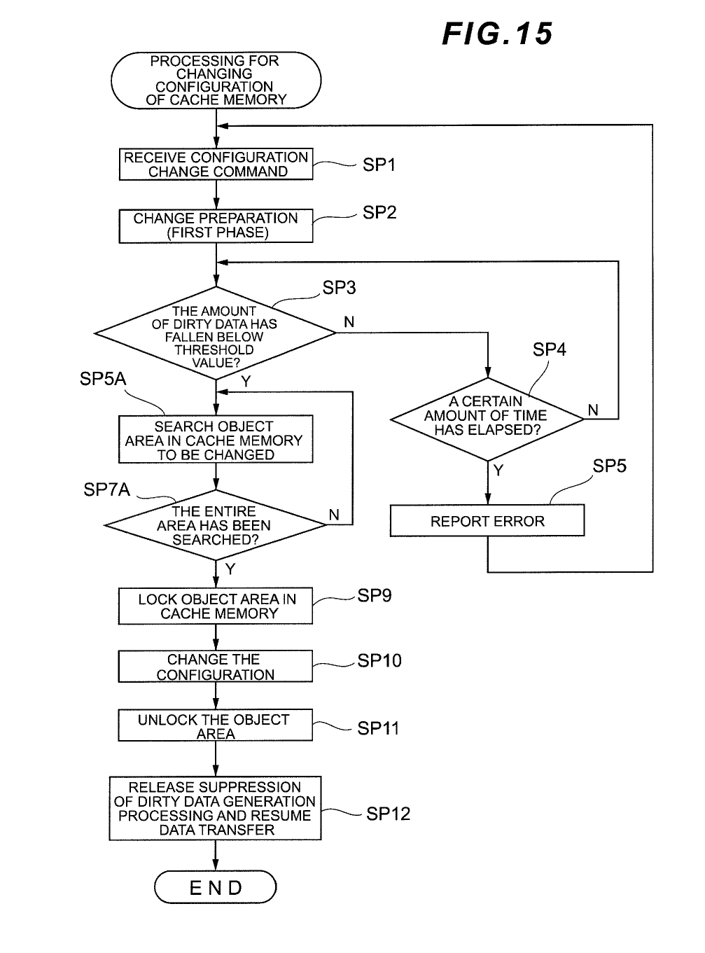

FIG. 15 shows an example of steps of a method for changing the configuration of a cache memory according to the second embodiment. Incidentally, since steps in FIG. 15 with the same reference numerals as those in FIG. 14 are almost the same as those in FIG. 14, FIG. 15 will be explained below by mainly focusing on the difference between the steps in FIG. 14 and the steps in FIG. 15.

In the second embodiment, processing from step SP5 to SP7 is different from that in the first embodiment. In the second embodiment, the data transfer control unit 24 continues to use the write-after method to transfer data without switching the transfer method after execution of step SP3 and then further executes the following processing. Incidentally, at least the data transfer method is different in the first embodiment because after the execution of step SP3, the data transfer control unit 24 switches to the write-through method to transfer data.

Firstly, as triggered by reception of a configuration change command (SP1), the data transfer control unit 24 executes steps SP2 to SP5 as part of a change preparation step. The data transfer control unit 24 further executes the following steps SP5A, SP7A as the change preparation step. Specifically speaking, the data transfer control unit 24 searches the object area in the cache memory 25 which is the target to be changed (SP5A). If no dirty data remains in each segment of the object area in the cache memory 25, the data transfer control unit 24 marks the segment, thereby preventing the marked segment from being used in the I/O processing with the host system 60.

On the other hand, if any dirty data exists in a segment of the object area in the cache memory 25, the data transfer control unit 24 copies that dirty data to another segment which is not the target to be changed, marks the segment in the object area, prevents the marked segment from being used in the I/O processing with the host system 60. The data transfer control unit 24 further purges (deletes) the data in the segment to be changed. Regarding the data copied to the area which is not the target to be changed, the data transfer control unit 24 executes, for example, normal destage processing.

The data transfer control unit 24 checks whether the entire object area in the cache memory 25 has been searched or not (SP7A). If the entire area has not been searched, the data transfer control unit 24 returns to step SP5A and executes the processing; and if the entire area has been searched, the data transfer control unit 24 starts executing the processing from step SP9. No dirty data will remain in each segment of the object area whose configuration is to be changed, by executing the above-described search processing on the entire object area in the cache memory 25. Therefore, at that point in time, the CPU 21 as the processor can change the configuration of the cache memory 25 without stopping the I/O processing with the host system 60.

In step SP9, the data transfer control unit 24 changes, for example, a partition of which the logical units take charge (hereinafter referred to as PTT), changes the PPT size or the segment size, or adds or deletes the PTT as the configuration change of the object area in the cache memory 25 in the same manner as in the first embodiment.

Next, as triggered by an event where the dirty data no longer exists in the object area in the cache memory 25, the processor 21 changes the configuration of the cache memory 25 relating to the object area (SP10: configuration change step). The data transfer control unit 24 locks the object area in the cache memory 25 in the same manner as in the first embodiment (SP11). Next, the data transfer control unit 24 releases the suppression of the dirty data generation processing, while it cancels the mark given to each segment of the object area in the cache memory 25 and resumes data transfer via the cache memory 25 (SP12: restoration step).

Incidentally, if the configuration change target is the entire area of the cache memory 25 in the second embodiment, the data transfer control unit 24 may first divide the entire area of the cache memory 25 into a plurality of unit areas and sequentially execute steps SP5A, SP7A, SP9 described above for each unit area. In this case, the data transfer control unit 24 copies dirty data existing in the object segment from the currently processed unit area to another unit area.

### (2-2) Advantageous Effects of the Present Embodiment

In the change preparation step according to the second embodiment as described above, the data transfer control unit 24 transfers data via the cache memory 25 by the write-after method and searches the object area in the cache memory 25; and if any dirty data as data which has not been completely written to the storage devices 40 or the host systems 60 no longer exists in each segment of the object area in the cache memory 25, the data transfer control unit 24 marks the relevant segment. On the other hand, if any dirty data exists in a segment of the object area in the cache memory 25, the data transfer control unit 24 copies the dirty data to another segment which is not the target to be changed, marks the segment in the object area, and then deletes the dirty data existing in the marked segment. As triggered by the event where the dirty data no longer exists in the object area in the cache memory 25, the CPU 21 causes the data transfer control unit 24 to change the configuration of the cache memory 25 relating to the object area. Furthermore, in the restoration step, the data transfer control unit 24 cancels the mark given to each segment of the object area in the cache memory 25 and resumes data transfer via the cache memory 25.

As a result, the same advantageous effects as those obtained by the first embodiment can be exhibited; and since it is unnecessary to change the data transfer from the write-through method, it is possible to further suppress the influence on the I/O processing with the host systems 60 as compared to the first embodiment. Even if a large amount of dirty data exists in the cache memory 25, or even if drives such as SATA (Serial Advanced Technology Attachment) drives that require longer access time are used, it is possible to reduce the time required to execute the processing for destaging the dirty data or change the configuration of the cache memory 25 in a short period of time. Also, even if destaging the data in the cache memory 25 fails due to, for example, a failure, it is possible to prevent the data from remaining in the cache memory 25.

In the configuration change step according to the second embodiment, the data transfer control unit 24 regulates input to and output from the object area in the cache memory 25, and the CPU21 changes the configuration of the cache memory 25 relating to the object area. Subsequently, in the restoration step, the data transfer control unit 24 releases the regulation of the input to and output from the object area in the cache memory 25 and resumes data transfer via the cache memory 25.

In the change preparation step according to the second embodiment, the data transfer control unit 24 divides the entire area of the cache memory 25 into a plurality of unit areas and sequentially searches each unit area. If the dirty data no longer exists in each segment of the unit area, the data transfer control unit 24 marks that segment. On the other hand, if any dirty data exists in a segment of the unit area, the data transfer control unit 34 copies the dirty data from the currently processed unit area to another unit area, marks the currently processed unit area, and then deletes the dirty data existing in that marked unit area.

As a result, the configuration of the entire area of the cache memory 25 can be changed by dividing the entire area into parts and processing each part.

### (3) Example of Configuration Change of Memory Area for Cache Memory 25

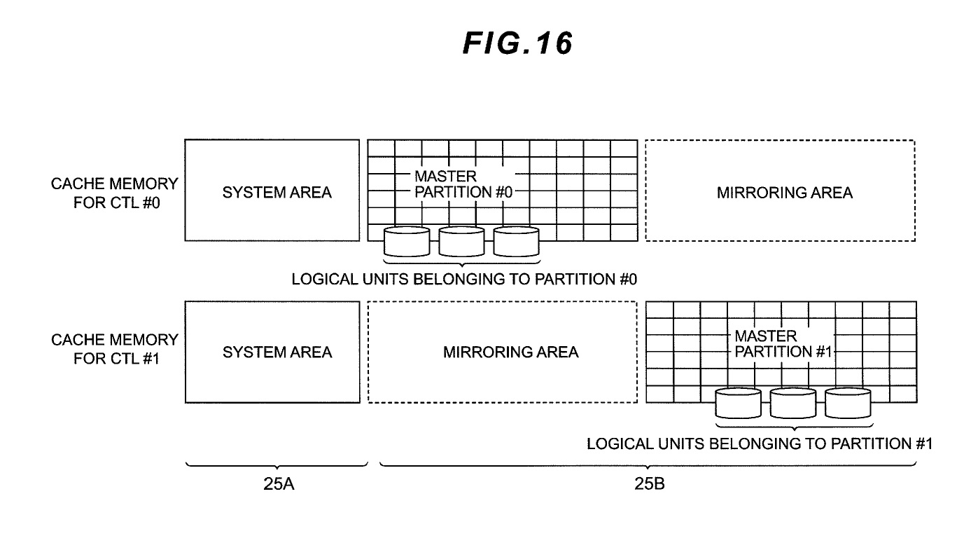

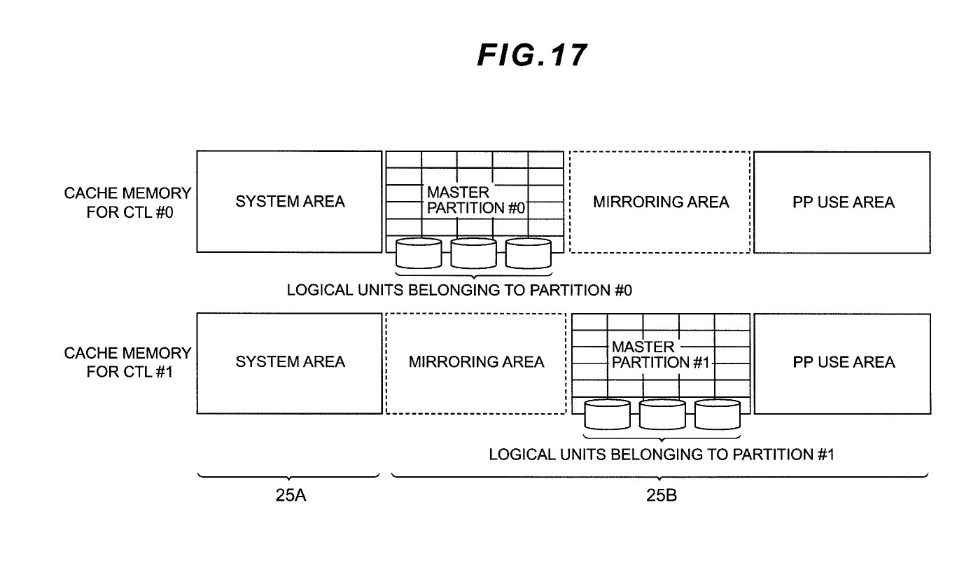

FIG. 16 and FIG. 17 respectively show examples in which the configuration of the memory area of the cache memory 25 is changed. An upper row represents the memory area of the cache memory 25 for the controller CTL #0, while a lower row represents the memory area of the cache memory 25 for the controller CTL #1. Incidentally, FIG. 16 shows an example of the configuration of the memory area before a configuration change, while FIG. 17 shows an example of the configuration of the memory area after the configuration change.

Before a configuration change as shown in FIG. 16, the memory area of the cache memory 25 for the controller CTL #0 as indicated in the upper row has a system area 25A (corresponding to the management information area) as well as a master partition #0 and mirroring area as a user data area 25B. Three logical units belonging to the master partition #0 are allocated to the master partition #0. The mirroring area is an area used for mirroring of the master partition #1 of the cache memory 25 for the controller CTL #1 described later.

Meanwhile, before a configuration change as shown in FIG. 16, the memory area of the cache memory 25 for the controller CTL #1 as indicated in the lower row has a system area 25A as well as a master partition #0 and mirroring area as a user data area 25B. Three logical units belonging to the master partition #1 are allocated to the master partition #1. The mirroring area is an area used for mirroring of the master partition #0 of the cache memory 25 for the controller CTL #0 described later.

On the other hand, after a configuration change as shown in FIG. 17, the memory area of the cache memory 25 for the controller CTL #0 as indicated in the upper row has the system area 25A (corresponding to the management information area) as well as the master partition #0, mirroring area, and PP use area as the user data area 25B. The capacity of the master partition #0 is reduced and the three logical units belonging to the master partition #0 are allocated to the master partition #0 in the same manner as described above. The size of the mirroring area is reduced and is an area for mirroring of the master partition #1 of the cache memory 25 for the controller CTL #1 described later. Specifically speaking, a new PP use area is formed in the memory area of the cache memory 25 for the controller CTL #0. The PP use area represents a memory area secured by the aforementioned program product. The program product can change the configuration of components other than the cache memory 25, however it is useful when applied to the cache memory 25 in the first and second embodiments described above.

On the other hand, after the configuration change as shown in FIG. 17, the memory area of the cache memory 25 for the controller CTL #1 as indicated in the lower row has the system area 25A as well as the master partition #0, mirroring area, and PP use area as the user data area 25B. The capacity of the master partition #1 is reduced and the three logical units belonging to the master partition #1 are allocated to the master partition #1 in the same manner as described above. The capacity of the mirroring area is reduced and is an area for mirroring of the master partition #0 in the cache memory 25 for the controller CTL #0 described later. Specifically speaking, a new PP use area is formed in the memory area of the cache memory 25 for the controller CTL #1.

### (4) Other Embodiments

The above-described embodiments are examples given for the purpose of describing this invention, and it is not intended to limit the invention only to these embodiments. Accordingly, this invention can be utilized in various ways unless the utilizations depart from the gist of the invention. For example, processing sequences of various programs have been explained sequentially in the embodiments described above; however, the order of the processing sequences is not particularly limited to that described above. Therefore, unless any conflicting processing result is obtained, the order of processing may be changed or concurrent operations may be performed. Incidentally, the second embodiment may be partly combined with the configuration according to the first embodiment.

### REFERENCE SIGNS LIST

20 Controller
21 CPU
24 Data transfer control unit
25 Cache memory
26 Host I/F
27 Drive I/F
30 Controller
31 CPU
34 Data transfer control unit
35 Cache memory
36 Host I/F
37 Drive I/F
40 Disk drive
50 Network
60 Host system
70 Management terminal

1. A storage system comprising:
a storage device for providing a logical volume which is accessible from a host system; and
a controller including a data transfer control unit for controlling input to and output from the logical volume in response to an input-output request from the host system, a cache memory for temporarily storing data input to and output from the logical volume, and a processor for controlling the data transfer control unit and managing the configuration of the cache memory;
wherein the data transfer control unit transfers data via the cache memory by a write-after method; and as triggered by an event where an amount of input to and output from an object area in the cache memory falls below a certain value, the data transfer control unit switches from the write-after method to a write-through method and then transfers data via the cache memory and waits until there is no longer any input to and output from the object area in the cache memory; and
wherein as triggered by an event where there is no longer any input to and output from the object area in the cache memory, the processor changes the configuration of the cache memory relating to the object area and causes the data transfer control unit to switch from the write-through method to the write-after method and resume data transfer via the cache memory.

2. The storage system according to claim 1, wherein the data transfer control unit checks whether or not an amount of dirty data, which is data existing in the object area in the cache memory and which has not been completely written to the logical volume, has fallen below a specified threshold value; and
as triggered by an event where the amount of dirty data has fallen below the specified threshold value, the data transfer control unit switches from the write-after method to the write-through method, and transfers data via the cache memory, then checks whether or not any dirty data exists in the object area in the cache memory; and
wherein as triggered by an event where the dirty data no longer exists in the object area in the cache memory, the processor changes the configuration of the cache memory relating to the object area.

3. The storage system according to claim 2, wherein the data transfer control unit suppresses execution of processing for generating the dirty data so that the amount of input to and output from the object area in the cache memory falls below the certain value.

4. The storage system according to claim 1, wherein after the input to and output from the object area in the cache memory is regulated by the data transfer control unit, the processor changes the configuration of the cache memory relating to the object area; and
after releasing the regulation of the input to and output from the object area in the cache memory, the data transfer control unit switches from the write-through method to the write-after method and resumes data transfer via the cache memory.

5. The storage system according to claim 1, wherein the data transfer control unit destages the dirty data at each logical volume allocated to the object area in the cache memory.

6. The storage system according to claim 8, wherein the data transfer control unit synchronously manages data in the host system and data in the cache memory; and
manages the data in the cache memory and data in the logical volume on the storage device asynchronously.

7. A method for changing a configuration of a cache memory for a storage system, the storage system including:
a storage device for providing a logical volume which is accessible from a host system; and
a controller including a data transfer control unit for controlling input to and output from the logical volume in response to an input-output request from the host system, a cache memory for temporarily storing data input to and output from the logical volume, and a processor for controlling the data transfer control unit and managing the configuration of the cache memory;
the method comprising:
a change preparation step executed by the data transfer control unit for transferring data via the cache memory by a write-after method; and as triggered by an event where an amount of input to and output from an object area in the cache memory falls below a certain value, then switching from the write-after method to a write-through method and then transferring data via the cache memory and waiting until there is no longer any input to and output from the object area in the cache memory;
a configuration change step executed by the processor for changing the configuration of the cache memory relating to the object area as triggered by an event where there is no longer any input to and output from the object area in the cache memory; and
a restoration step executed by the data transfer control unit for switching from the write-through method to the write-after method and resuming data transfer via the cache memory.

8. The method for changing the configuration of the cache memory for the storage system according to claim 7, wherein the change preparation step includes:
a first change preparation step executed by the data transfer control unit for checking whether an amount of dirty data, which is data existing in the object area in the cache memory and which has not been completely written to the logical volume, has fallen below a specified threshold value or not; and
a second change preparation step executed by the data transfer control unit for switching from the write-after method to the write-through method when triggered by an event where the amount of dirty data has fallen below the specified threshold value, and checking whether or not any dirty data exists in the object area in the cache memory with transferring data via the cache memory by the write-through method; and
wherein in the configuration change step, the processor changes the configuration of the cache memory relating to the object area when triggered by an event where the dirty data no longer exists in the object area in the cache memory.

9. The method for changing the configuration of the cache memory for the storage system according to claim 8, wherein in the change preparation step,
the data transfer control unit suppresses execution of processing for generating the dirty data so that the amount of input to and output from the object area in the cache memory falls below the certain value.

10. The method for changing the configuration of the cache memory for the storage system according to claim 7, wherein in the configuration change step,
the processor changes the configuration of the cache memory relating to the object area after the input to and output from the object area in the cache memory is regulated by the data transfer control unit; and
in the restoration step, after releasing the regulation of the input to and output from the object area in the cache memory, the data transfer control unit switches from the write-through method to the write-after method and resumes data transfer via the cache memory.

11. The method for changing the configuration of the cache memory for the storage system according to claim 7, wherein the data transfer control unit destages the dirty data at each logical volume allocated to the object area in the cache memory.

12. The method for changing the configuration of the cache memory for the storage system according to claim 8, wherein the data transfer control unit manages data in the host system and data in the cache memory by synchronizing them; and
manages the data in the cache memory and data in the logical volume on the storage device asynchronously.

13. A method for changing a configuration of a cache memory for a storage system, the storage system including:
a storage device for providing a logical volume which is accessible from a host system; and
a controller including a data transfer control unit for controlling input to and output from the logical volume in response to an input-output request from the host system, a cache memory for temporarily storing data input to and output from the logical volume, and a processor for controlling the data transfer control unit and managing the configuration of the cache memory;
the method comprising:
a change preparation step executed by the data transfer control unit for searching an object area in the cache memory with transferring data via the cache memory by a write-after method; and if dirty data as data which has not been completely transferred to the storage device or the host system does not exist in each segment of the object area in the cache memory, then marking the segment; and if the dirty data exists in a object segment of the object area in the cache memory, then copying the dirty data to a non-object segment, marking the object segment, and then deleting the dirty data existing in the object segment in the object area;
a configuration change step executed by the processor for changing the configuration of the cache memory relating to the object area as triggered by an event where the dirty data no longer exists in the object area in the cache memory; and
a restoration step executed by the data transfer control unit for cancelling the mark given to each segment in the object area in the cache memory and resuming data transfer via the cache memory.

14. The method for changing the configuration of the cache memory for the storage system according to claim 13, wherein in the configuration change step, the processor changes the configuration of the cache memory relating to the object area after the input to and output from the object area in the cache memory is regulated by the data transfer control unit; and
in the restoration step, the data transfer control unit releases the regulation of the input to and output from the object area in the cache memory, and resumes data transfer via the cache memory.

15. The method for changing the configuration of the cache memory for the storage system according to claim 13, wherein in the change preparation step,
the data transfer control unit searches each of unit areas obtained by dividing the entire area of the cache memory into a plurality of unit areas; and if the dirty data no longer exists in each segment of the unit area, the data transfer control unit marks the segment; and if the dirty data exists in a segment of the unit area, the data transfer control unit copies the dirty data to another unit area which is not the currently processed unit area, and marks the currently processed unit area, and then deletes the dirty data existing in the currently processed unit area.
